(19) United States
(12) Patent Application Publication
(10) Pub. No.: US 2016/0288408 A1
(43) Pub. Date: Oct. 6, 2016

(54) METHOD OF APPLYING A COATING ONTO WORKPIECES AND DEVICE FOR COATING WORKPIECES

(71) Applicant: HOMAG HOLZBEARBEITUNGSSYSTEME GMBH, Schopfloch (DE)

(72) Inventor: Johannes Schmid, Starzach (DE)

(73) Assignee: Homag Holzbearbeitungssysteme GmbH, Schopfloch (DE)

(21) Appl. No.: 15/035,289

(22) PCT Filed: Nov. 6, 2014
(86) PCT No.: PCT/EP2014/073923

§ 371 Date: May 9, 2016

(30) Foreign Application Priority Data
Nov. 7, 2013 (DE) 102013222636.5

(51) Int. Cl. B29C 65/14; B29C 65/00; B29C 65/78

(52) U.S. Cl. CPC B29C 65/1412; B29C 65/1432; B29C 65/787; B29C 66/7487

(57) ABSTRACT

The invention relates to a method for applying a coating, which preferably consists at least partly of plastic, onto workpieces, which preferably consist at least partly of wood, wood materials, plastic, or the like. The coating is activated or melted in a connection region, and the coating is connected to the workpiece by the connection region, said connection region being irradiated with incoherent radiation, in particular infrared radiation, which is preferably dispensed by a light-emitting diode arrangement, for activation or melting purposes. The invention further relates to an arrangement for coating a workpiece in such a manner.

### TECHNICAL FIELD

The invention relates to a method of applying a coating, which preferably consists at least partly of plastic, onto workpieces, which preferably consist at least partly of wood, derived wood products, plastic or the like, in which the coating is activated at least in one bonding region and is bonded to the workpiece in this region. According to the invention, a device for such coating of workpieces is also provided.

### PRIOR ART

Devices and methods of the aforementioned type are widely used for the coating of workpieces and for bonding workpieces to a coating. In particular, laser radiation is used for activation, as is described in EP 1 163 864 B1, for example. With laser radiation, a sufficiently high energy input into the bonding region can take place, by which the bonding region is activated.

However, apart from high costs, the use of a laser entails a complex construction and a comparatively high space requirement for the laser components.

### DESCRIPTION OF THE INVENTION

In view of this background, it is the object of the present invention to facilitate a method and a device for coating a workpiece of the aforementioned type with a simple construction and a low space requirement.

According to the invention, this object is solved by the method of applying a coating according to claim 1 and the device for coating workpieces according to claim 6. Particularly preferred further developments of the invention are given in the dependent claims.

Accordingly, a method of applying a coating, which preferably consists at least partly of plastic, onto workpieces, which preferably consist at least partly of wood, derived wood products, plastic or the like, is provided, with the coating being activated, in particular melted, with the method at least in one bonding region, and the coating being bonded to the workpiece by the bonding region, with the bonding region being irradiated with incoherent radiation, in particular infrared radiation, which is preferably emitted by a light-emitting diode arrangement, for activation, in particular melting.

Moreover, it is provided according to the invention that the device for coating workpieces, which preferably consist at least partly of wood, derived wood products, plastic or the like, with at least one coating, which preferably consists at least partly of plastic, by bonding the coating and the workpiece in a bonding region comprises a support and an activation device, with the support serving to support at least one workpiece and the activation device comprising a light-emitting diode arrangement for irradiating the bonding region for activating, in particular melting, the coating in the bonding region, with the light-emitting diode arrangement serving to emit radiation, in particular infrared radiation, and being arranged such that the bonding region is irradiated with the radiation.

By using incoherent radiation such as radiation emitted by a light-emitting diode arrangement, the bonding region can be activated with simple and space-saving constructive means, a high energy input by monochromatic radiation being possible in particular due to the use of the light-emitting diode arrangement.

The invention is based on the idea to implement the coating of a workpiece using reduced constructive effort and space requirements without having to accept restrictions with regard to the quality of the bonding between the coating and the workpiece. In particular, coherent radiation generated by a laser is not necessary. In this way, numerous complex components of a laser device requiring installation space are not necessary, such as, for example, beam guidance means, beam deflection means, beam focusing means, etc.

The bonding region is to be understood in general as the region in which the bonding between the coating and the workpiece takes place. In particular, the bonding region is to be understood also as the region to be bonded when bonding between the bonding region and the workpiece has not yet taken place. In particular, the bonding takes place in the region in which the activation takes place and sufficient mechanical bonding, for example by pressing, subsequently takes place between the coating and the workpiece.

The activation is to be understood as energy supply by electromagnetic radiation and in particular in that the coating in the bonding region is chemically changed by electromagnetic radiation. In particular, the activation leads to the melting of the coating in the bonding region and to a liquefaction of the coating at least in sections.

The coating is to be understood as a layer which is to be applied onto the workpiece at least in sections. The coating itself can consist of plural materials, sections and/or layers such that, for example, only a part of an adhesive layer or a layer that can be made adhesive, which is part of the coating, is activated. Preferably, the coating comprises an integral or discrete adhesive layer which develops adhesive properties due to activation and energy supply.

Preferably, monochromatic, electromagnetic radiation in a wavelength range of 0.78 to 1000 μm is essentially used, which corresponds to the infrared part of the electromagnetic spectrum.

Particularly advantageous further developments of the invention are given in the dependent claims which will be discussed below. In particular, the features of the dependent claims dependent on the method claim also pertain to the claimed device. Likewise, the claimed method is characterized by the claims dependent on the device claim.

In particular, the activation device, i.e. the device, is free of a resonator and/or an optical amplifier. This reduces the size of the radiation source and enables an arrangement thereof also in the vicinity of the bonding region. The light-emitting diode arrangement serves to emit incoherent radiation and is arranged such that the bonding region is irradiated with the incoherent radiation. This is to be understood in contrast to a device in which the radiation is generated by a laser which comprises a resonator and an optical amplifier and emits coherent radiation.

Preferably, the coating is directly irradiated such that the beam path between the radiation source, in particular the light-emitting diode arrangement, and the bonding region is free during activation, in particular free of beam-shaping elements, furthermore in particular free of a lens. Likewise, in the device, the beam path between the light-emitting diode arrangement and the bonding region is free during activation, in particular free of beam-shaping elements, furthermore in particular free of a lens. Owing to this direct irradiation of the bonding region, further elements, for example beam-shaping elements, do not have to be procured and adjusted, which additionally simplifies the construction and makes it more compact and cost-efficient.

A further preference is that the radiation can be emitted by a light-emitting diode arrangement comprising at least one array and preferably plural arrays, each of which preferably comprises plural light-emitting diode chips. Accordingly, the device preferably comprises a light-emitting diode arrangement in which at least one array and preferably plural arrays are provided, each of which preferably comprises plural light-emitting diode chips.

Since plural light-emitting diode chips are compiled into one array, the radiated power of the light-emitting diode arrangement can be increased, by which the energy input into the bonding region can be increased. Moreover, radiation can be applied extensively to the bonding region.

According to the method, the arrays and/or chips can be switched on and off in accordance with the area of the bonding region. Likewise, the arrays and/or chips of the device can be switched on and off in accordance with the area of the bonding region. This means that the arrays and/or chips can be controlled separately and a selection can be made, for example by an operator, as to which array and/or which chip is to be switched on and off. For example, if a large-surface bonding region is to be activated, many or all arrays and/or chips are switched on. However, if only a relatively small bonding region is to be activated, it is sufficient to switch on only a small part of the arrays, possibly only one array. By individually switching on and off arrays and chips, the respective desired area of the bonding region can be activated.

It is preferred that the radiation source of the incoherent radiation, in particular the light-emitting diode arrangement, is arranged at a distance of 2 to 20 mm, preferably 5 to 15 mm, from the bonding region during activation of the bonding region and/or between the workpiece and the bonding region. Likewise, in the device, the light-emitting diode arrangement, in particular the array(s), and the bonding region are spaced apart during activation preferably by 2 to 20 mm, further preferably 5 to 15 mm, and/or the light-emitting diode arrangement, in particular the array(s), is preferably arranged between the workpiece and the bonding region during activation. This means that the light-emitting diode arrangement is provided directly at the joint gap. For example, additional light guides for guiding coherent light generated in a remotely arranged laser are not necessary. Once again, this leads to a simple, compact and cost-efficient construction.

If the radiation source of the incoherent radiation such as the light-emitting diode arrangement is arranged between the workpiece and the bonding region for activation or the distance between the radiation source of the incoherent radiation such as the light-emitting diode arrangement and the bonding region is between 2 and 20 mm or 5 to 15 mm during activation, the energy input can take place with sufficient intensity, and it can be ensured at the same time that there is a distance between the individual components, which is sufficient for operability. Moreover, a space-saving implementation of the coating and a space-saving device for coating the workpieces is possible.

A further preference is that the entire radiating area at the light-emitting diode arrangement, in particular the radiating area of the entirety of the arrays, is at least 3000 mm², preferably at least 4000 mm². The entire radiating area is to be understood as the area which leads to a radiation contribution, i.e. the area by which the radiation can be emitted. If the radiating area is at least 3000, preferably at least 4000, further preferably at least 5000 mm², an area to be activated or a large-surface bonding region can be activated and bonded. The coating can be applied in an accelerated manner thereby.

A further preference is that the radiated power of a light-emitting diode chip is at least 100 W and/or the radiated power of an array is at least 2 kW, preferably 2.5 kW. With such light-emitting diodes, a sufficiently large energy input onto the coating can take place.

The method can be carried out by a device in which the support is configured as a continuous conveying device such that with the method the workpieces are transported in a conveying direction. Alternatively, the method can also be carried out by a device designated as a so-called stationary machine, in which the workpieces are stationary and the activation device is moved. Combinations of these two concepts are also conceivable.

Further features and advantages of the invention will become more evident by means of the detailed description below.

### BRIEF DESCRIPTION OF THE DRAWINGS

FIG. 1 shows a device for coating workpieces according to the present invention;

FIG. 2 shows a light-emitting diode arrangement according to the invention with arrays and light-emitting diode chips.

### DETAILED DESCRIPTION OF A PREFERRED EMBODIMENT

A preferred embodiment of the present invention will be described in detail below with reference to the enclosed drawings.

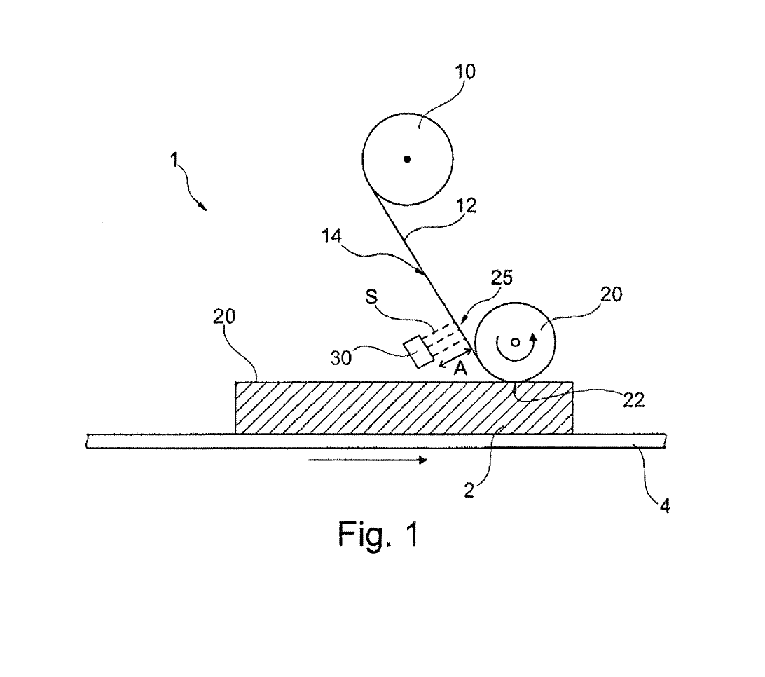

In the device, i.e. the coating device 1, for coating workpieces 2, bonding a coating 12 configured as strip material and the workpiece 2 takes place in a bonding region 25, as is shown in a side view in FIG. 1. During activation, the bonding region 25 is provided upstream of a pressing device 20 which generates the pressing region 22 on the workpiece 2 by pressing the coating 12 onto the workpiece 2. In general, the pressing region 22 is identical to the bonding region 25 after the region previously activated has been pressed completely onto the workpiece.

In the continuous process shown, a support, i.e. a conveying device 4, serves to support and convey the workpiece(s) 2. In the embodiment shown, conveyance takes place from the left to the right, as is indicated in FIG. 1 by the arrow.

The coating 12 consists of a general layer and an adhesive layer or a layer of a material 14 that can be made adhesive, which is activated by the incoherent radiation in the bonding region 25. In the embodiment shown, the coating 14 or a part thereof is melted.

The coating 12 is provided as strip material in the form of a roll in the feeding device 10. The coating is guided out of the feeding device 10 and subsequently brought between the upper surface 2a of the workpiece 2 and the pressing device 20 pressing thereon. The pressing device 20 is a pressure roller which rolls over the surface 2a of the workpiece 2 and in this way presses the coating 12 onto the surface 2a of the workpiece 2.

Between the feeding device 10 and the pressing device 20, the activation device such as the light-emitting diode arrangement 30 is provided which is arranged such that electromagnetic radiation, in particular infrared radiation, impinges onto a region, i.e. the bonding region 25, of the coating. The coating 12 or rather the adhesive agent 14 is activated in this region.

The activation device such as the light-emitting diode arrangement 30 is provided upstream of the pressing device. Moreover, the light-emitting diode arrangement does not comprise a resonator or optical amplifier. Consequently, the light-emitting diode arrangement emits incoherent radiation onto the bonding region.

It is evident from FIG. 1 that the coating 12 is directly irradiated and that “nothing” is arranged in the beam path S between the radiation source 30 and the bonding region 25. Neither a lens nor any other beam-shaping elements are provided.

The distance A between the light-emitting diode arrangement 30 and the bonding region 25 can be indicated as the shortest length of the beam path S, as is shown in FIG. 1. The distance A is between 2 and 20 mm and preferably between 5 and 15 mm. In other words, the light-emitting diode arrangement 30 is arranged between the workpiece 2 and the bonding region 25 during activation.

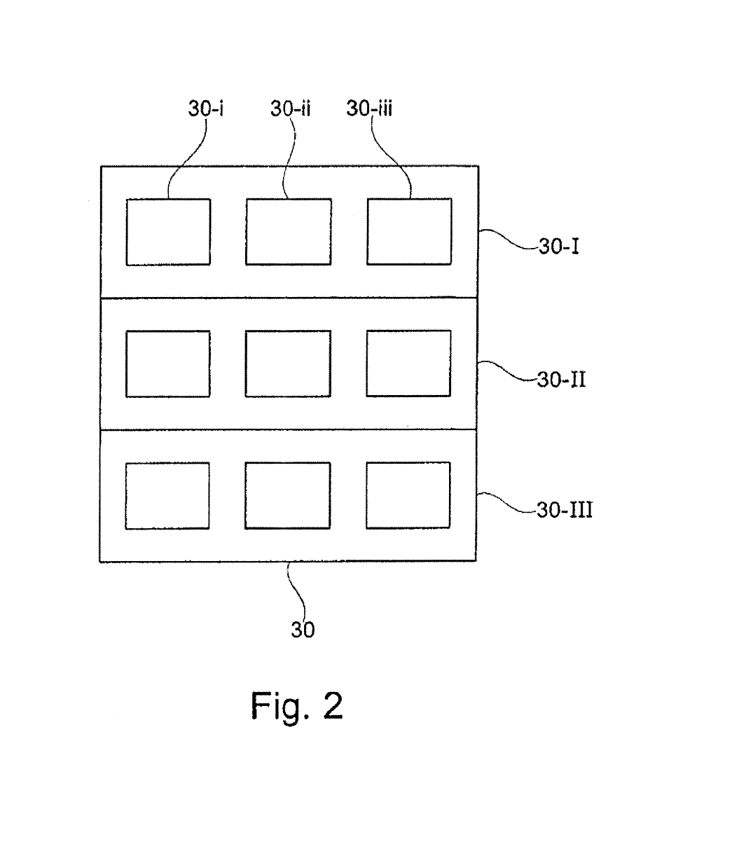

FIG. 2 shows a front view of the light-emitting diode arrangement 30 with three arrays 30-I, II, III, each array in turn comprising three chips 30-i, ii, iii. The individual arrays and/or chips can be switched on and off in accordance with the size or area of the bonding region 25. The entire radiating area of the light-emitting diode arrangement 30 in FIG. 2, i.e. the total of the radiating area of the nine chips, is at least 4000 mm². In this regard, the radiated power of a chip 30-i, ii, iii is at least 100 W, and the radiated power of an array 30-I, II, III is at least 2 kW. With reference to FIG. 2, it is clarified that the number of the arrays and chips shown is merely an easily sketchable light-emitting diode arrangement, whereas the number of arrays and chips is, of course, to be selected accordingly per array during implementation.

1. A method of applying a coating, onto workpieces, comprising
activating the coating in at least one bonding region,
bonding the coating to the workpiece by the bonding region, and
irradiating the bonding region with incoherent radiation for activation.

2. The method according to claim 1, wherein the coating is directly irradiated such that a beam path (S) between the radiation source and the bonding region is free during activation.

3. The method according to claim 1, wherein the radiation is emitted by a light-emitting diode arrangement comprising at least one array which comprises plural light-emitting diode chips.

4. The method according to claim 3, wherein the arrays and/or chips are switched on and off in accordance with the area of the bonding region.

5. The method according to claim 1, wherein the radiation source of the incoherent radiation is arranged at a distance (A) of 2 to 20 mm, from the bonding region during activation of the bonding region and/or between the workpiece and the bonding region.

6. A device for coating workpieces, with at least one coating, by bonding a coating and the workpiece in a bonding region, the device comprising:
a support for supporting at least the one workpiece and
an activation device comprising a light-emitting diode arrangement for irradiating the bonding region with incoherent radiation for activating, in particular melting, the coating in the bonding region,
characterized in that
the light-emitting diode arrangement serves to emit the radiation which is arranged such that the bonding region is irradiated with the radiation.

7. The device according to claim 6, wherein the activation device is free of a resonator and/or an optical amplifier and/or the light-emitting diode arrangement serves to emit incoherent radiation and is arranged such that the bonding region is irradiated with incoherent radiation.

8. The device according to claim 7, wherein the light-emitting diode arrangement comprises at least one array, which comprises plural light-emitting diode chips.

9. The device according to claim 8, wherein the arrays and/or chips can be switched on and off in accordance with the area of the bonding region.

10. The device according to claim 7, wherein a beam path (S) between the light-emitting diode arrangement and the bonding region is free during activation.

11. The device according to claim 6, wherein the light-emitting diode arrangement and the bonding region are spaced apart during activation by 2 to 20 mm, and/or the light-emitting diode arrangement is arranged between the workpiece and the bonding region during activation.

12. The device according to claim 6, wherein the entire radiating area at the light-emitting diode arrangement, is at least 3000 mm².

13. The device according to claim 8, wherein the radiated power of the light-emitting diode chip is at least 100 W.

14. The method of claim 1, wherein the incoherent radiation comprises infrared radiation.

15. The method of claim 2, wherein the bonding region is free of a beam-shaping element or of a lens during activation.

16. The device of claim 6, wherein the incoherent radiation comprises infrared radiation.

17. The device of claim 10, wherein the bonding region is free of a beam-shaping element or of a lens during activation.

18. The device of claim 8, wherein the radiated power of the array is at least 2 kW.

19. The method of claim 1, wherein the incoherent radiation is emitted by a light-emitting diode arrangement.

20. The method of claim 1, wherein the workpieces are chosen at least partly from the group consisting of wood, derived wood products, plastic and the like.

21. The device of claim 6, wherein the workpieces are chosen at least partly from the group consisting of wood, derived wood products, plastic and the like.

22. The method of claim 1, wherein the coating consists at least partly of plastic.

23. The device of claim 6, wherein the coating consists at least partly of plastic.
